(19) United States
(12) Patent Application Publication
(10) Pub. No.: US 2007/0266539 A1
(43) Pub. Date: Nov. 22, 2007

(54) Multipackage applicator device

(76) Inventors: Paul H. Miner, Lakemoor, IL (US); Barry Dauber, Damascus, MD (US)

Correspondence Address: Pauley Petersen & Erickson, Suite 365, 2800 West Higgins Road, Hoffman Estates, IL, 60169, US

(21) Appl. No.: 11/784,217

(22) Filed: Apr. 5, 2007

Related U.S. Application Data
(60) Provisional application No. 60/790,696, filed on Apr. 10, 2006.

(51) Int. Cl. B23P 11/00; B23P 11/02; B23P 19/02

(52) U.S. Cl. 29/428; 29/235; 29/446

(57) ABSTRACT

A device for applying a flexible carrier to a plurality of containers includes a plurality of distal jaws and a plurality of proximate jaws, spaced apart from the distal jaws. A flexible carrier having a plurality of apertures is positioned between the distal jaws and the proximate jaws and an actuator, engaged with the plurality of distal jaws and/or the plurality of proximate jaws, is used to incrementally separate the distal jaws from the proximate jaws thereby stretching the flexible carrier to permit insertion of the plurality of containers within each of the plurality of apertures.

### BACKGROUND OF THE INVENTION

1. Field of the Invention

This invention relates to a device for applying a carrier to a plurality of containers such as cans or bottles.

2. Description of Prior Art

Conventional container carriers are often used to unitize a plurality of similarly sized containers, such as cans, bottles, jars and boxes and/or similar containers that require unitization. Flexible plastic ring carriers are one such conventional container carrier.

Flexible plastic ring carriers may be used to unitize groups of four, six, eight, twelve or other suitable groups of containers into a convenient multipackage. Often, merchandisers and/or bottlers desire options for unitizing groups of individual containers into desirable multipackages. Large bottling operations utilize automated packaging lines that can efficiently place hundreds of containers per minute into corresponding flexible carriers. Such equipment is large and impractical for smaller operations. In particular, smaller, low-volume merchandisers and/or bottlers that do not have the necessary volume requirements, floor space or equipment for automated operations may desire a hand-operated device for low-volume application of flexible carriers to groups of containers.

Existing equipment for such hand application of flexible carriers to groups of containers include a small, pencil-sized device with an angled end, operated in a manner similar to a shoe horn, for stretching individual apertures of the flexible carriers into engagement with individual containers. This process is time consuming and inconsistent. In addition, table-top fixtures exist whereby a carrier is stretched into position using a large rotatable handle to separate the apertures of the carrier for placement of containers therein. These fixtures are often large, expensive and unwieldy.

### SUMMARY OF THE INVENTION

The present invention is directed to a device for applying a flexible carrier to a plurality of containers. The device according to this invention preferably includes a plurality of distal jaws and a plurality of proximate jaws, spaced apart from the distal jaws. A flexible carrier having a plurality of container apertures may be positioned within the device so that each jaw is engaged with a container aperture in the flexible carrier. Each of the distal jaws and proximate jaws are preferably attached relative to a rod, such as through a respective jaw plate, to permit movement of the distal jaws relative to the proximate jaws.

An actuator such as a trigger is preferably engaged with the rod to enable an incremental separation of the distal jaws relative to the proximate jaws. As the trigger is actuated, the distal jaws are separated from the proximate jaws thereby separating the flexible carrier placed therein.

At a predetermined or otherwise appropriate distance of separation between the distal jaws and the proximate jaws, the flexible carrier is provided with a suitable stretch or tension to permit insertion of the plurality of containers, one container within each of the plurality of apertures. Following insertion of the containers within the flexible carrier, the device may then be removed from around the unitized plurality of containers. The resulting multipackage is then suitable for sale, shipping or similar disposition. A release may then be actuated to release a fixed position between the distal jaws and the proximate jaws thereby resetting the device.

### BRIEF DESCRIPTION OF THE DRAWINGS

The above-mentioned and other features and objects of this invention will be better understood from the following detailed description taken in conjunction with the drawings wherein:

FIG. 1 is a top view of a device according to one preferred embodiment of this invention;

FIG. 2 is a side view of the device shown in FIG. 1;

FIG. 3 is a front view of the device shown in FIG. 1;

FIG. 4 is a top view of a device engaged with a flexible carrier according to one preferred embodiment of this invention; and

FIG. 5 is a top perspective view of a device engaged with a flexible carrier and a plurality of containers according to one preferred embodiment of this invention.

### DESCRIPTION OF PREFERRED EMBODIMENTS

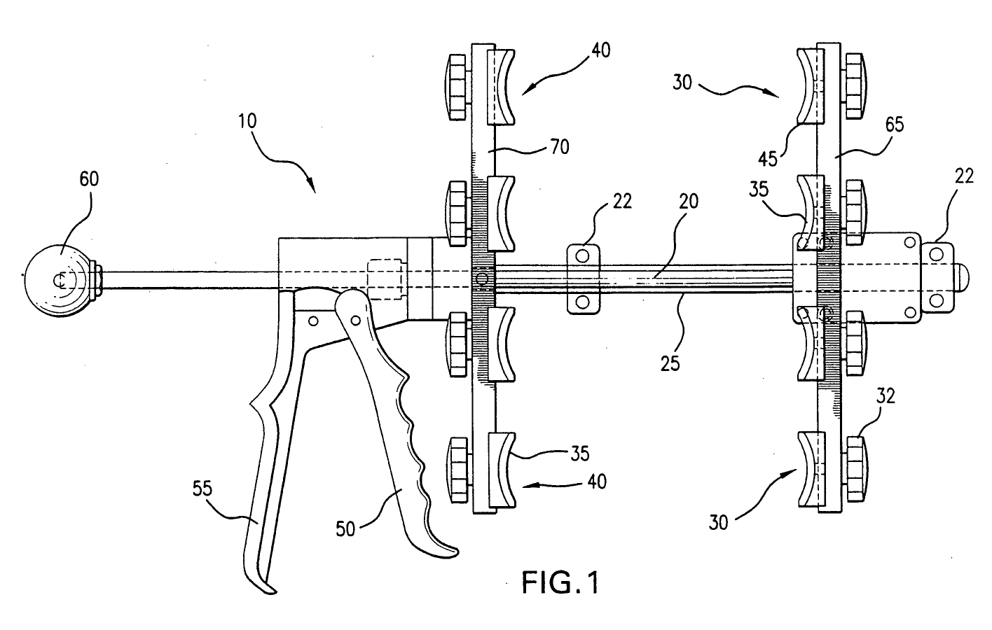

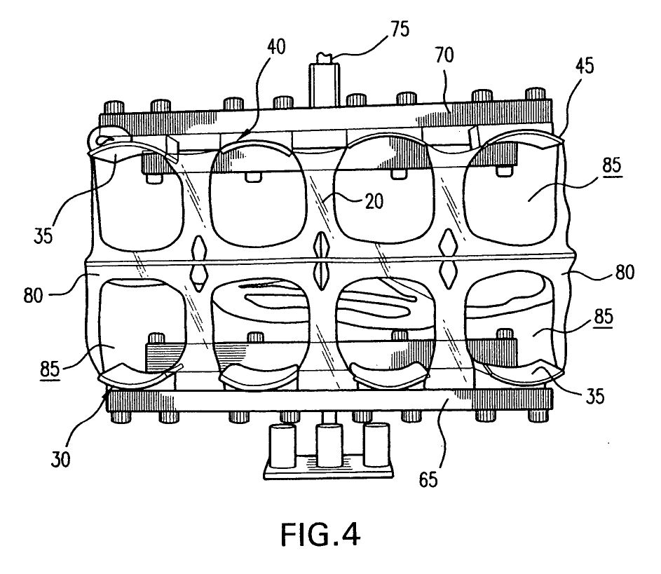

FIGS. 1-5 show device 10 for unitizing eight containers within a flexible carrier to form a unitized package. Although FIGS. 1-5 illustrate a multipackage having eight containers, the illustrations are exemplary, and the invention is not limited to the flexible carriers or device shown. However, device 10 may be configured and used to unitize four, eight, twelve or any other desired number of containers and/or flexible carriers. In addition, device 10 may be configured and used to unitize multiple sets of a desired number of containers simultaneously, such as two sets of four containers or four sets of two containers.

Device 10 is used to unitize a plurality of appropriate containers 5, preferably cans or bottles. However, any other commonly unitized container may be used with device 10 according to this invention. Containers 5 are preferably like-sized within a single flexible carrier 80.

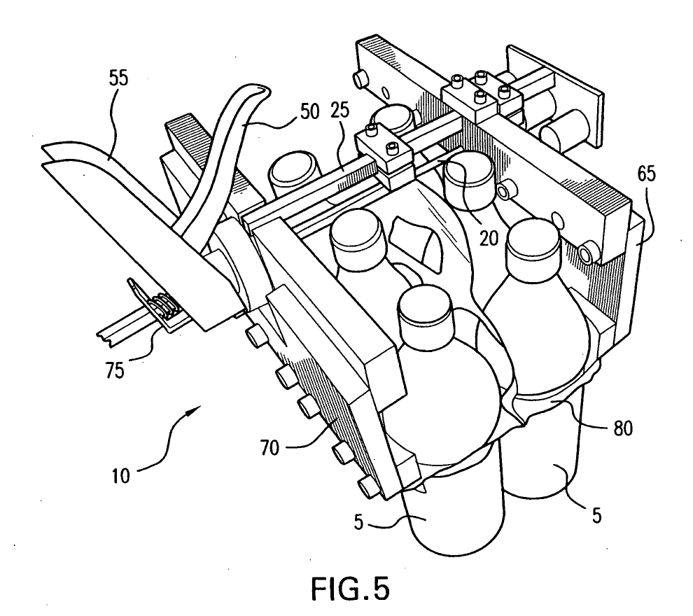

A multipackage results from application of flexible carrier 80 to the plurality of containers 5. Flexible carriers 80 are generally applied to such containers 5 by stretching flexible carrier 80, specifically the material surrounding individual container apertures 85 around a perimeter of container 5, and allowing the stretched flexible carrier 80 to recover, thereby providing a tight engagement. Flexible carrier 80 is typically applied to a chime or rib of container 5, where this structure exists, or to a main sidewall, such as shown in FIG. 5.

According to a preferred embodiment of this invention, device 10 for applying flexible carrier 80 to a plurality of containers 5 includes a plurality of distal jaws 30 and a plurality of proximate jaws 40 spaced apart from the distal jaws 30. As best shown in FIG. 1, each jaw of the distal jaws 30 and the proximate jaws 40 includes a generally curved inner surface 35 and an upwardly extending shoulder 45 having a generally corresponding curve. Curved inner surface 35 preferably generally corresponds with a contour of a sidewall of container 5. As such, when flexible carrier 80 is applied to jaws 30, 40 on shoulder 45, flexible carrier 80 is urged into a flush engagement with containers 5. Alternatively, any other suitable jaw configuration known to those having ordinary skill in the art may be utilized that permits flexible carrier 80 to be stretched between distal jaws 30 and proximate jaws 40.

As shown in the figures, each of the distal jaws 30 are preferably positioned on a distal jaw plate 65 and each of the proximate jaws 40 are preferably positioned on a proximate jaw plate 70. As best shown in FIG. 3, jaw plates 65, 70 may comprise an “X” configuration. Alternatively, jaw plates 65, 70 may be configured in any other suitable manner that permits attachment of the plurality of jaws 30,40 to each respective jaw plate 65, 70. In addition, and as best shown in FIG. 3, jaw plates 65, 70 may include at least one foot positioned on a bottom of the respective jaw plate 65, 70 to maintain device 10 in an upright position on a work surface.

Distal jaws 30 and/or proximate jaws 40 are preferably adjustable relative to distal jaw plate 65 and proximate jaw plate 70, respectively. As shown in FIG. 1, thumb screw 32 or similar adjustment mechanism may fasten distal jaws 30 and/or proximate jaws 40 into position and may be loosened to enable upward, downward, lateral, forward and/or rearward motion of jaw 30, 40 relative to the respective jaw plate 65, 70.

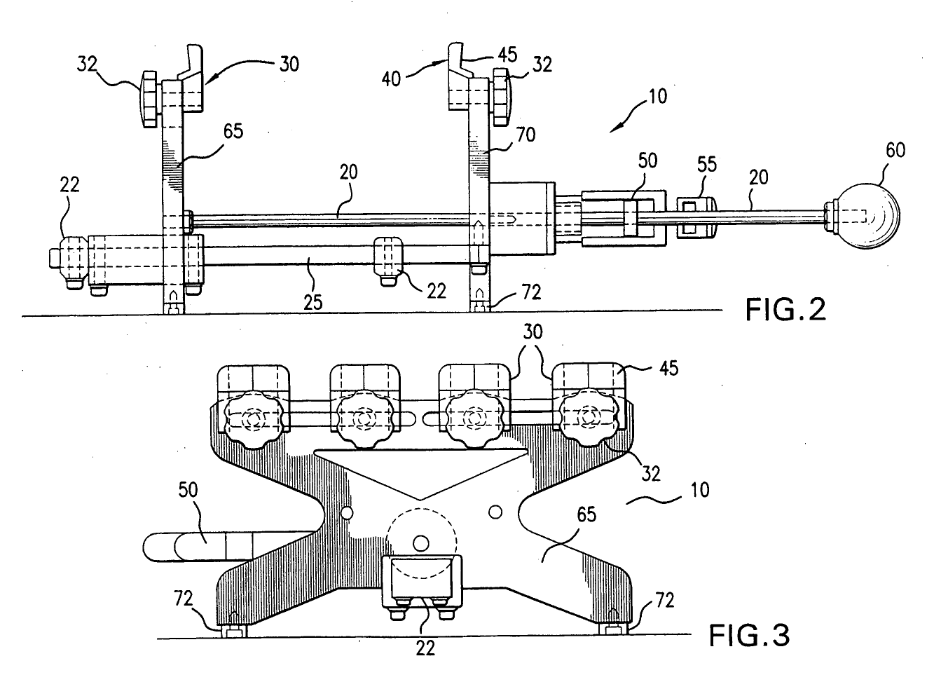

As shown in FIGS. 1 and 2, device 10 further includes rod 20 extending between distal jaws 30 and proximate jaws 40. More specifically, distal jaw plate 65 and proximate jaw plate 70 are preferably positioned on rod 20. At least one of distal jaw plate 65 and proximate jaw plate 70 are preferably affixed to rod 20 to permit movement of distal jaws 30 relative to proximate jaws 40. According to a preferred embodiment of this invention, distal jaw plate 65 and thus distal jaws 30 are affixed relative to rod 20 and proximate jaw plate 70 and thus proximate jaws 40 are moveable relative to rod 20. As a result of this preferred embodiment, distal jaws 30 move relative to proximate jaws 40 when rod 20 is extended relative to device 10 as described in more detail below.

An actuator, such as trigger 50 or similar structure for enabling an incremental separation of distal jaws 30 relative to proximate jaws 40, is preferably engaged with rod 20. The actuator enables an incremental separation of distal jaws 30 relative to proximate jaws 40 with a user input such as a squeezing motion. According to one preferred embodiment of this invention, trigger 50 is pivotable relative to grip 55 that is fixed to device 10. As trigger 50 is moved or compressed relative to grip 55, proximate jaw plate 70 and thus proximate jaws 40 move along rod 20 and distal jaw plate 65 and distal jaws 30 thereby move away from proximate jaws 40. Each movement or compression of trigger 50 relative to grip 55 preferably results in an additional incremental separation between distal jaws 30 and proximate jaws 40, thereby resulting in a ratcheting action of distal jaws 30 relative to proximate jaws 40, or more specifically, rod 20 relative to trigger 50.

According to one preferred embodiment of this invention, release 75 is positioned with respect to rod 20. As best shown in FIG. 5, release 75 may be depressed or otherwise actuated to release a fixed position between the distal jaws 30 and the proximate jaws 40. Release 75 may be a brake or similar structure that engages rod 20 or otherwise prevents undesired motion of distal jaws 30 relative to proximate jaws 40 until actuated.

As best shown in FIG. 2, guide bar 25 may be positioned between the distal jaws 30 and the proximate jaws 40. Guide bar 25 is preferably positioned generally parallel with rod 20 and extends through, or is otherwise engaged with, distal jaw plate 65 and proximate jaw plate 70. In this manner, guide bar 25 permits linear movement of the plurality of distal jaws 30 relative to the plurality of proximate jaws 40. According to one preferred embodiment of this invention, guide bar 25 comprises a rectangular cross-section, however, guide bar 25 may comprise any suitable cross-section that permits aligned linear movement of distal jaws 30 relative to proximate jaws 40. For example, in applications that require a high stress stretching of flexible carrier 80, guide bar 25 may comprise an I-beam configuration thereby maintaining a parallel alignment between the plurality of distal jaws 30 and the plurality of proximate jaws 40.

According to one preferred embodiment of this invention, and as best shown in FIG. 2, at least one stop 22 and preferably two stops 22 are positioned on guide bar 25 and define a limit of travel of distal jaws 30 relative to proximate jaws 40. As shown in FIG. 2, one stop 22 is positioned near an outer end of guide bar 25 and another stop 22 is positioned near proximate jaw plate 70. A distance between stops 22 may be adjusted to permit use of different flexible carriers 80 in association with different configurations of containers 5. In addition, a length of rod 20 and/or guide bar 25 may be similarly adjusted to permit application of flexible carriers 80 to larger and/or smaller containers 5.

As a result of the described relationship among rod 20, guide bar 25 and trigger 50, device 10 according to this invention permits the application of a large force to separate distal jaws 30 from proximate jaws 40 within a relatively small package. The ratcheting action of device 10 and the resulting incremental separation of distal jaws 30 from proximate jaws 40 enable stretching of flexible carrier 80 in a uniform and predictable manner without need for a table-mounted fixture, a power source or other mechanical assistance required in existing applicating machines and fixtures.

Handle 60 may be additionally positioned with respect to rod 20, such as shown in FIGS. 1 and 2. Handle 60 is preferably used to adjust a distance between the distal jaws 30 and the proximate jaws 40. Accordingly, handle 60 may be pushed or pulled relative to grip 55 and/or trigger 50 to adjust a distance of distal jaws 30 from proximate jaws 40, particularly to reset a distance between distal jaws 30 and proximate jaws 40 following operation of device 10.

In operation, device 10 is preferably positioned on a work surface, such as on feet 72, or is hand held by the user. Flexible carrier 80 having a plurality of apertures 85 is then loaded into device 10 by positioning apertures 85 on each corresponding jaw 30, 40 so that flexible carrier 80 extends between the distal jaws 30 and the proximate jaws 40.

The user then actuates trigger 50 to initiate incremental separation of the distal jaws 30 from the proximate jaws 40. According to a preferred embodiment of this invention, trigger 50 is actuated until distal jaw plate 65 reaches stop 22 at an outer end of guide bar 25. At that predetermined distance, flexible carrier 80 is provided with a desired stretch or tension to permit insertion of the plurality of containers 5 within each of the plurality of apertures 85. It may be preferable to include stop 22 at an outer limit of motion to prevent excessive stretching or “necking” of flexible carrier 80.

Following insertion of containers 5 within flexible carrier 80, device 10 may be removed from around the unitized plurality of containers 5. Alternatively, the unitized plurality of containers 5 may be removed from device 10. The user may then reset device 10 by moving handle 60 to restore a starting position of distal jaws 30 relative to proximate jaws 40.

According to one preferred embodiment of this invention, device 10 may include an integrated platform, blocks or similar surfaces to limit vertical movement of containers 5 upon insertion. For example, device 10 may include one or more plates that prevent containers 5 from sliding beyond a pre-determined vertical position. In such a way, device 10 permits containers 5 to be applied so that flexible carrier 80 is positioned at a consistent vertical position in every application.

In addition, device 10 preferably permits a user to unitize groups of containers 5 that are individually positioned within a tray, pallet or other larger group of containers 5. In this manner, a user can position the device within a case of forty containers of bottled water, for example, and apply a flexible carrier 80 to a desired number of containers 5, such as eight. Repeating this operation five times, a user can unitize a case of bottled water into five multipackages of eight containers each without disturbing or removing the containers 5 from the carton.

While in the foregoing specification this invention has been described in relation to certain preferred embodiments thereof, and many details have been set forth for purpose of illustration, it will be apparent to those skilled in the art that device 10 is susceptible to additional embodiments and that certain of the details described herein can be varied considerably without departing from the basic principles of the invention.

1. A device for applying a flexible carrier to a plurality of containers, the device comprising:
a rod;
a plurality of distal jaws positioned on the rod;
a plurality of proximate jaws positioned on the rod and spaced apart from the distal jaws;
an actuator engaged with the rod to incrementally separate the distal jaws from the proximate jaws.

2. The device of claim 1 further comprising:
a guide bar positioned between the distal jaws and the proximate jaws, the guide bar permitting linear movement of the plurality of distal jaws relative to the plurality of proximate jaws.

3. The device of claim 2 further comprising:
at least one stop positioned on the guide bar and defining a limit of travel of the distal jaws relative to the proximate jaws.

4. The device of claim 1 further comprising:
a release positioned with respect to the rod, the release for releasing a fixed position between the distal jaws and the proximate jaws.

5. The device of claim 1 further comprising:
a handle positioned with respect to the rod, the handle for adjusting a distance between the distal jaws and the proximate jaws; and
a trigger engaged with the rod to incrementally separate the distal jaws from the proximate jaws.

6. The device of claim 1 further comprising:
a proximate jaw plate positioned on the rod, each of the plurality of proximate jaws positioned on the proximate jaw plate; and
a distal jaw plate positioned on the rod, each of the plurality of distal jaws positioned on the distal jaw plate.

7. The device of claim 6 further comprising:
at least one foot positioned on the proximate jaw plate and the distal jaw plate to maintain the device in an upright position.

8. The device of claim 1 wherein each jaw of the plurality of distal jaws and the plurality of proximate jaws comprises a generally curved inner surface and an upwardly extending shoulder having a generally corresponding curve.

9. The device of claim 1 wherein a position of each jaw of the plurality of distal jaws and the plurality of proximate jaws is adjustable.

10. A device for unitizing a plurality of containers with a flexible carrier having a plurality of apertures, the device comprising:
a plurality of distal jaws;
a plurality of proximate jaws spaced apart from the distal jaws, wherein the flexible carrier is positioned between the distal jaws and the proximate jaws; and
an actuator engaged with at least one of the plurality of distal jaws and the plurality of proximate jaws to incrementally separate the distal jaws from the proximate jaws thereby stretching the flexible carrier to permit insertion of the plurality of containers within each of the plurality of apertures.

11. The device of claim 10 further comprising:
a rod positioned between the distal jaws and the proximate jaws, the trigger operatively connected with the rod.

12. The device of claim 11 further comprising:
a guide bar positioned between the distal jaws and the proximate jaws, the guide bar permitting linear movement of the plurality of distal jaws relative to the plurality of proximate jaws.

13. The device of claim 11 further comprising:
a release positioned with respect to the rod, the release for releasing a fixed position between the distal jaws and the proximate jaws.

14. The device of claim 10 wherein each jaw of the plurality of distal jaws and the plurality of proximate jaws comprises a curved, upwardly extending shoulder.

15. A method of applying a flexible carrier having a plurality of apertures to a corresponding plurality of containers, the method comprising the steps of:
placing the flexible carrier on a device having a plurality of distal jaws and a plurality of proximate jaws so that each aperture of the plurality of apertures engages one jaw of the plurality of distal jaws or the plurality of proximate jaws;
incrementally separating the distal jaws from the proximate jaws to stretch the flexible carrier;
placing a container of the plurality of containers into each aperture; and
removing the flexible carrier from the distal jaws and the proximate jaws so that the plurality of containers are engaged within the flexible carrier.

16. The method of claim 15 wherein the distal jaws are incrementally separated from the proximate jaws with a ratcheting action.

17. The method of claim 15 further comprising the step of:
squeezing a trigger to incrementally separate the distal jaws from the proximate jaws.

18. The method of claim 15 further comprising the step of:
actuating a release to release a fixed distance between the distal jaws and the proximate jaws.

19. The method of claim 15 further comprising the step of:
moving a handle to adjust a distance between the distal jaws and the proximate jaws.

20. The method of claim 15 further comprising the step of:
guiding the distal jaws in a fixed path from the proximate jaws along a guide bar.
